(19) United States
(12) Patent Application Publication
(10) Pub. No.: US 2009/0066407 A1
(43) Pub. Date: Mar. 12, 2009

(54) CHARGE PUMP SYSTEMS AND METHODS THEREOF

(75) Inventors: Robert J. Bowman, Fairport, NY (US); Hans C. Rotmann, Coral Gables, FL (US)

Correspondence Address: NIXON PEABODY LLP - PATENT GROUP, 1100 CLINTON SQUARE, ROCHESTER, NY, 14604, US

(73) Assignee: Rochester Institute of Technology, Rochester, NY (US)

(21) Appl. No.: 12/209,828

(22) Filed: Sep. 12, 2008

Related U.S. Application Data
(60) Provisional application No. 60/993,403, filed on Sep. 12, 2007.

(51) Int. Cl. G05F 1/10

(52) U.S. Cl. 327/536

(57) ABSTRACT

A charge pump system includes a plurality of charge pump cells coupled in series between an input and an output and a voltage regulator system. The voltage regulator system is coupled to an output from the plurality of charge pump cells and to each of the plurality of charge pump cells to control a charge and discharge in one or more of the plurality of charge pump cells.

This application claims the benefit of U.S. Provisional Patent Application Ser. No. 60/993,403 filed Sep. 12, 2007, which is hereby incorporated by reference in its entirety.

### FIELD OF THE INVENTION

This invention generally relates to charge pump circuits and, more particularly, to charge pump systems for thin film, crystalline silicon on glass technology and methods thereof.

### BACKGROUND

A variety of different types of flat panel displays, such as a liquid crystal displays and organic light-emitting diode displays, have become ubiquitous in consumer electronics today. With this variety of different types of displays has also come a variety of different operating voltages required by control systems in each of these displays.

More specifically, in prior displays power typically has been supplied to each of these control systems from a discrete integrated circuit attached to the display by chip-on-glass bonding. Display manufacturers prefer to integrate these power conversion components on the display glass using thin film transistor technology to offer a single module solution to their customers.

An example of a prior art charge pump cell 10 used to provide power is illustrated in FIG. 1. The charge pump cell 10 includes capacitors 12(1) and 12(2) and switches 14(1)-14(8). One plate of the capacitor 12(1) is coupled to one end of switches 14(1) and 14(2) and another plate of the capacitor 12(1) is coupled to one end of switches 14(3) and 14(4). The other end of switches 14(1) and 14(3) are coupled to the voltage input 16 and the other end of switches 14(2) and 14(4) are coupled to the voltage output 18. Additionally, one plate of the capacitor 12(2) is coupled to one end of switches 14(5) and 14(6) and another plate of the capacitor 12(2) is coupled to one end of switches 14(7) and 14(8). The other end of switches 14(5) and 14(7) are coupled to the voltage input 16 and the other end of switches 14(6) and 14(8) are coupled to the voltage output 18.

The parallel arrangement of the illustrated switch-capacitor circuits in this prior art charge pump cell 10 is necessary to ensure that the output voltage is twice the input voltage at all times. The antiphase clocking scheme for controlling the operation of the switches 14(1)-14(8) illustrated in FIG. 1 ensures proper operation of this prior art charge pump cell.

### SUMMARY

A charge pump system in accordance with embodiments of the present invention includes a plurality of charge pump cells coupled in series between an input and an output and a voltage regulator system. The voltage regulator system is coupled to an output from the plurality of charge pump cells and to each of the plurality of charge pump cells to control at least one of a charge and a discharge in one or more of the plurality of charge pump cells.

A method for making a charge pump system in accordance with other embodiments of the present invention includes forming a plurality of charge pump cells which are coupled in parallel between an input and an output. A voltage regulator system is coupled to an output from the plurality of charge pump cells and to each of the plurality of charge pump cells to provide a clocking signal to control at least one of a charge and a discharge of one or more of the plurality of charge pump cells.

The present invention provides a number of advantages including providing an energy and area efficient, charge pump system. Additionally, the present invention provides a charge pump system which can be manufactured using low temperature, thin film, crystalline silicon on glass process technology which offers superior mobility and improved threshold voltage matching. Further, the present invention is able to provide a significant reduction in circuit footprint compared to prior systems allowing for higher usable display areas and higher drive current capabilities.

### BRIEF DESCRIPTION OF THE DRAWINGS

FIG. 1 is a block diagram of a prior art cross-coupled charge pump cell;

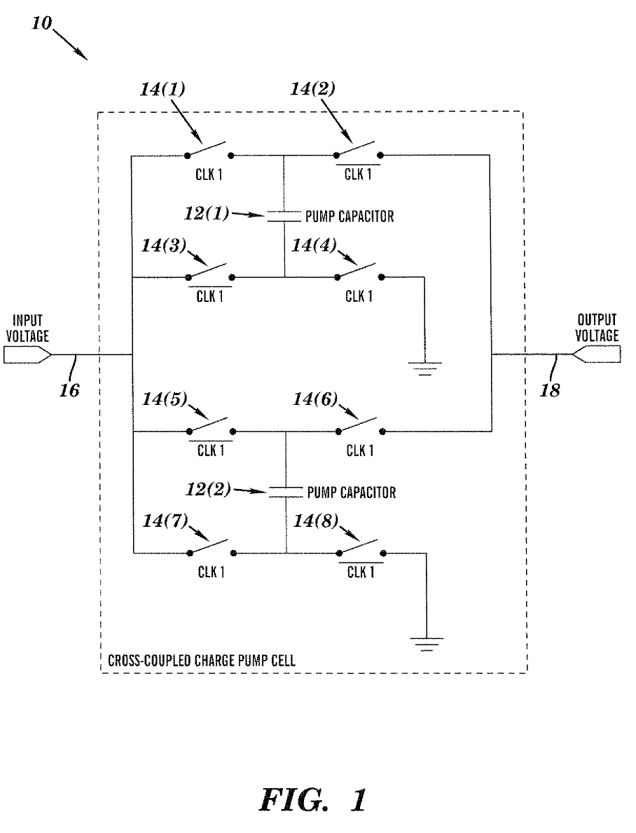

FIG. 2 is a block diagram of a charge pump system in accordance with other embodiments of the present invention;

FIG. 3 is a schematic diagram of a charge pump cell for use in the charge pump system illustrated in FIG. 2;

FIG. 4 is a schematic diagram of another charge pump cell for use in the charge pump system illustrated in FIG. 2; and

FIG. 5 is a timing diagram for the charge pump cell illustrated in FIG. 3.

### DETAILED DESCRIPTION

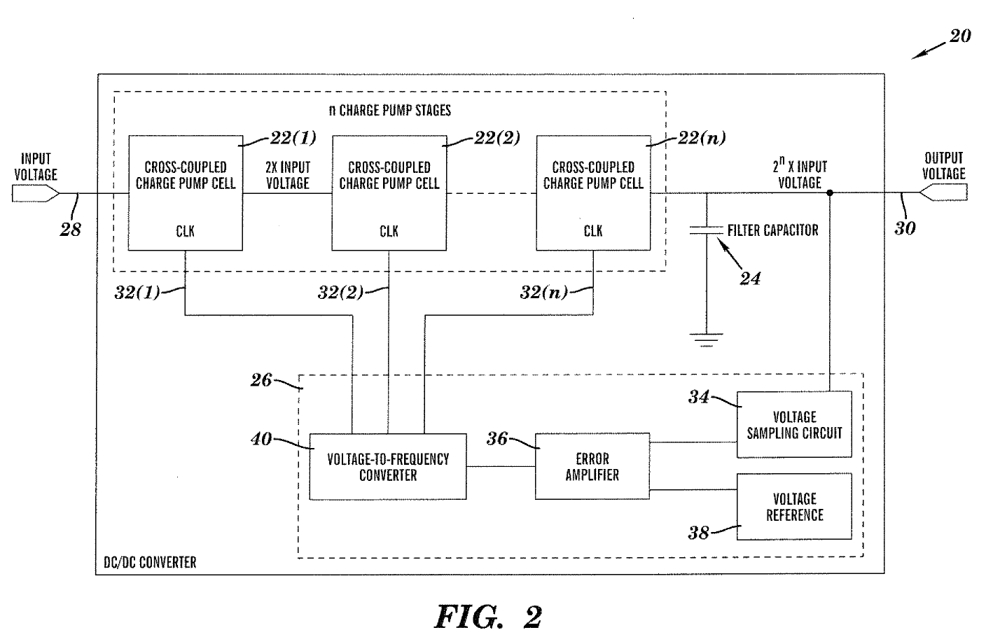

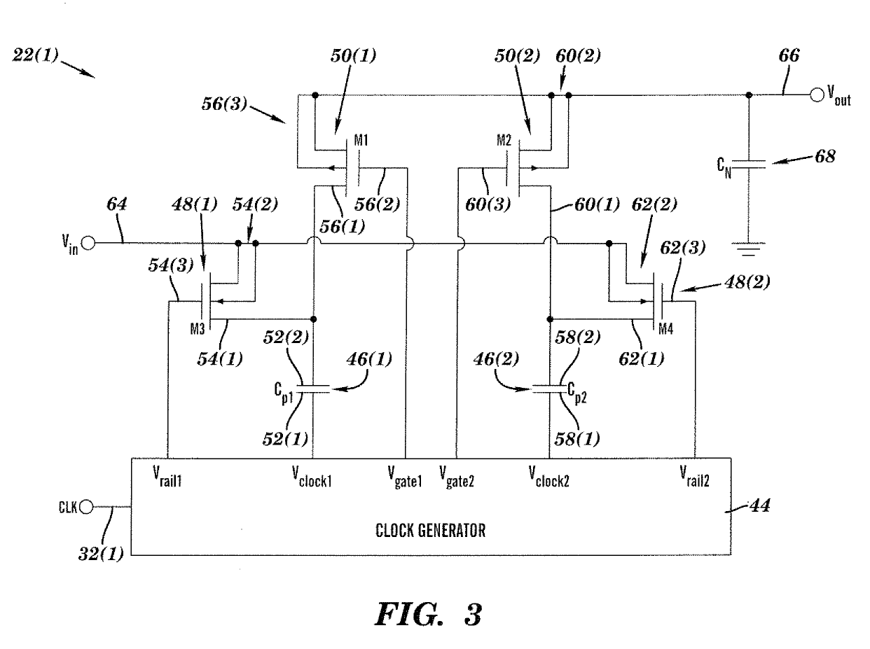

A charge pump system 20 in accordance with embodiments of the present invention is illustrated in FIGS. 2-3. The charge pump system 20 includes a plurality of charge pump cells 22(1)-22(n), a filter capacitor 24, a voltage regulator system 26, a voltage input 28, and a voltage output 30, although the charge pump system 20 can comprise other numbers and types of systems, devices, cells, units, and components in other configurations. The present invention provides a number of advantages including providing a circuit architecture for embodiments of the charge pump system which provide higher energy efficiency than prior charge pump systems. Additionally, other embodiments of the present invention provide greater area efficiency through the use of high k dielectrics in the charge pump cells and capacitors than prior charge pump systems. These and other benefits can be incorporated together or separately in embodiments of the present invention.

Referring more specifically to FIG. 2, the charge pump cells 22(1)-22(n) are coupled in series between the voltage input 28 and the voltage output 30, although other numbers of charge pump cells could be used, such as a single charge pump cell. The filter capacitor 24 is coupled between an output from the charge pump cell 22(n) and ground. The voltage regulator system 26 is coupled between the output from the charge pump cell 22(n) and clock inputs 32(1)-32(n) to each of the charge pump cells 22(1)-22(n).

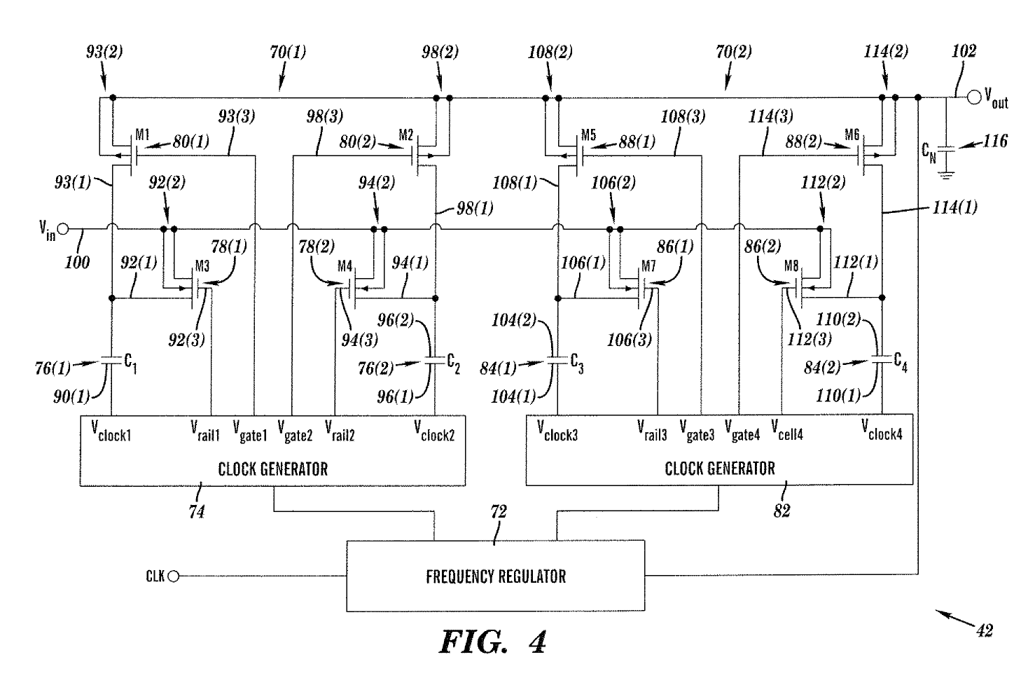

Referring to FIGS. 2 and 3, a diagram of one of the charge pump cells 22(1) is illustrated. Since the other charge pump cells 22(2)-22(n) are the same as the charge pump cell 22(1) in structure and operation, they will not be described again here. Although one type of charge pump cell 22(1) is illustrated, other types and numbers of charge pump cells can be used, such as the charge pump cell 42 illustrated and described herein with reference to FIG. 4 by way of example only.

The charge pump cell 22(1) includes a clock generator system 44, two capacitors Cₚ₁ or 46(1) and Cₚ₂ or 46(2), two input, metal-oxide-semiconductor field effect transistors (MOSFETs) M3 and M4 or 48(1) and 48(2), and two output MOSFETs M1 and M2 or 50(1) and 50(2), although the charge pump cell 22(1) could include other numbers and types of systems, devices, and components in other configurations. One plate 52(1) of capacitor 46(1) is coupled to V_{clock1} in the clock generator system 44 and the other plate 52(2) of capacitor Cₚ₁ is coupled to the drain 54(1) of MOSFET M3 or 48(1) and to the drain 56(1) of MOSFET 1I or 50(1). Additionally, one plate 58(1) of capacitor Cₚ₂ or 46(2) is coupled to V_{clock2} in the clock generator system 44 and the other plate 58(2) of capacitor Cₚ₂ or 46(2) is coupled to the drain 60(1) of MOSFET M4 or 48(2) and to the drain 62(1) of MOSFET M2 or 50(2). The gate 54(3) of MOSFET M3 or 48(1) is coupled to Vᵣₐᵢₗ₁ and the source 54(2) of MOSFET M3 or 48(1) is coupled to the voltage input Vᵢₙ or 64 to the charge pump cell 22(1). The gate 62(3) of MOSFET M4 or 48(2) is coupled to Vᵣₐᵢₗ₂ and the source 62(2) of MOSFET M4 or 48(2) is coupled to the voltage input Vᵢₙ or 64 to the charge pump cell 22(1). The gate 56(2) of MOSFET M1 or 50(1) is coupled to V_{gate1} and the source 56(3) of MOSFET M1 or 50(1) is coupled to the voltage output Vₒᵤₜ or 66 to the charge pump cell 22(1). The gate 60(3) of MOSFET M2 or 50(2) is coupled to V_{gate2} and the source 60(2) of MOSFET M2 or 50(2) also is coupled to the voltage output Vₒᵤₜ or 66 to the charge pump cell 22(1). In this particular embodiment, the filter capacitor C_{fil} or 68 coupled between the voltage output Vₒᵤₜ or 66 to the charge pump cell 22(1) and ground, although the filter capacitor C_{fil} could be in other locations and other numbers and types of filters could be used. Although MOSFETs are described in this and other exemplary embodiments herein, other types and numbers of switches could be used.

The charge pump cells 22(1)-22(n) are each made using a high-k dielectric material, such as hafnium oxide or tantalum oxide by way of example only, although other types of materials could be used. A high-k dielectric material refers to insulating materials with a higher dielectric constant (k) than the dielectric constant (k) of silicon dioxide which is about 3.9. Capacitance per unit area in a capacitor, such as capacitors 46(1), 46(2), and 68, is directly proportional to the insulator dielectric constant. Since most of the circuit footprint in the charge pump cells 22(1)-22(n) corresponds to the capacitors, the use of a high-k dielectric material for the capacitors yields a significant reduction in circuit footprint compared to prior systems.

Referring back to FIG. 2, the filter capacitor 24 reduces output voltage fluctuations due to the switching action of the cross-coupled charge pump cells 22(1)-22(n), although other types and numbers of filtering systems or no filtering system could be used. The filter capacitor 24 is made using a high-k dielectric material, such as hafnium oxide or tantalum oxide by way of example only, although other types of materials can be used. Again, a high-k dielectric material refers to insulating materials with a higher dielectric constant (k) than the dielectric constant (k) of silicon dioxide which is about 3.9. The use of a high-k dielectric for the filter capacitor 24 also yields a significant reduction in circuit footprint compared to prior systems.

The voltage regulator system 26 includes a voltage sampling system 34, an error amplifier system 36, a voltage reference system 38, and a voltage-to-frequency converter system 40, although the voltage regulator system 26 can comprise other numbers and types of systems, devices, and components in other configurations. The voltage sampling system 34 is coupled to receive an input from the output from the charge pump cell 22(n) and to provide an output to the error amplifier system 36. Additionally, the error amplifier system 36 is coupled to receive an input from the voltage reference system 38. The voltage-to-frequency converter system 40 is coupled to receive an input from the error amplifier system 36 and to provide outputs to each of the clock inputs 32(1)-32(n).

Referring to FIG. 4, another charge pump cell 42 which can be used for one or more of the charge pump cells 22(1)-22(n) in the charge pump system 20 is illustrated. The charge pump cell 42 has two charge pump cell units 70(1) and 70(2) and frequency regulator system 72, although the charge pump cell 42 can have other types and numbers of systems, devices, and elements, such as other numbers of charge pump cell units, in other configurations.

One charge pump cell unit 70(1) includes a clock generator 74, two capacitors C₁ and C₂ or 76(1) and 76(2), two input, metal-oxide-semiconductor field effect transistors (MOSFETs) M3 and M4 or 78(1) and 78(2), and two output MOSFETs M1 and M2 or 80(1) and 80(2), although the charge pump cell unit could include other numbers and types of systems, devices, and components in other configurations. Similarly, charge pump cell unit 70(2) includes another clock generator 82, two capacitors C₃ and C₄ or 84(1) and 84(2), two input, metal-oxide-semiconductor field effect transistors (MOSFETs) M7 and M8 or 86(1) and 86(2), and two output MOSFETs M5 and M6 or 88(1) and 88(2), although again the charge pump cell could include other numbers and types of systems, devices, and components in other configurations.

One plate 90(1) of capacitors C₁ or 76(1) is coupled to V_{clock1} in the clock generator 74 and the other plate 90(2) of capacitor C₁ or 76(2) is coupled to the drain 92(1) of MOSFET M3 or 78(1) and to the drain 93(1) of MOSFET M1 or 80(1). Additionally, one plate 96(1) of capacitor C₂ or 76(2) is coupled to V_{clock2} in the clock generator 74 and the other plate 96(2) of capacitor C₂ or 76(2) is coupled to the drain 94(1) of MOSFET M4 or 78(2) and to the drain 98(1) of MOSFET M2 or 80(2). The gate 92(3) of MOSFET M3 or 78(1) is coupled to Vᵣₐᵢₗ₁ and the source 92(2) of MOSFET M3 or 78(1) is coupled to the voltage input Vᵢₙ 100 to the charge pump cell 42. The gate 94(3) of MOSFET M4 or 78(2) is coupled to Vᵣₐᵢₗ₂ and the source 94(2) of MOSFET M4 or 78(1) is coupled to the voltage input Vᵢₙ or 100 to the charge pump cell 42. The gate 93(3) of MOSFET M1 or 80(1) is coupled to V_{gate1} and the source 93(2) of MOSFET M1 or 80(1) is coupled to the voltage output Vₒᵤₜ or 102 to the charge pump cell 42. The gate 98(3) of MOSFET M2 or 80(2) is coupled to V_{gate2} and source 98(2) of MOSFET M2 or 80(20 also is coupled to the voltage output Vₒᵤₜ or 102 to the charge pump cell 42.

Additionally, one plate 104(1) of capacitor C₃ or 84(1) is coupled to V_{clock3} in the clock generator 82 and the other plate 104(2) of capacitor C₃ or 84(1) is coupled to the drain 106(1) of MOSFET M7 or 86(1) and to the drain 108(1) of MOSFET M5 or 88(1). One plate 110(1) of capacitor C₄ or 84(2) is coupled to V_{clock4} in the clock generator and the other plate 110(2) of capacitor C₄ or 84(2) is coupled to the drain 112(1) of MOSFET M8 or 88(2) and to the drain 114(1) of MOSFET M6 or 88(2). The gate 106(3) of MOSFET M7 or 86(1) is coupled to Vᵣₐᵢₗ₃ and the source 106(2) of MOSFET M7 or 86(1) is coupled to the voltage input Vᵢₙ or 100 to the charge pump cell 42. The gate 112(3) of MOSFET M8 or 86(2) is coupled to Vᵣₐᵢₗ₄ and the source 112(2) of MOSFET M8 or 86(2) is coupled to the voltage input Vᵢₙ or 100 to the charge pump cell 42. The gate 108(3) of MOSFET M5 or 88(1) is coupled to V_{gate3} and the source 108(2) of MOSFET M5 or 88(2) is coupled to the voltage output Vₒᵤₜ or 102 to the charge pump cell 42. The gate 114(3) of MOSFET M6 or 88(2) is coupled to V_{gate4} and source of MOSFET M6 88(2) also is coupled to the voltage output Vₒᵤₜ or 102 to the charge pump cell 42. The filter capacitor C_{fil} or 116 is coupled between the voltage output Vₒᵤₜ or 102 to the charge pump cell 42 and ground, although the filter capacitor C_{fil} could be in other locations and other numbers and types of filters could be used.

The clock generators 74 and 82 for the charge pump cell units 70(1) and 70(2) convert the system clock signal from the frequency converter 72 into two non-overlapping clock signals. These clock signals, in turn, control the MOSFETs M3 and M4 or 78(1) and 78(2) for one charge pump cell unit 70(1) and control the input switches MOSFETs M7 and M8 or 86(1) and 86(2) for the charge pump cell unit 70(2). The non-overlapping clock signals are also used to generate the remaining control signals (V_{CLK1}, V_{CLK2}, Vᵣₐᵢₗ₁, Vᵣₐᵢₗ₂, V_{gate1} and V_{gate2}) in one charge pump cell unit 70(1) and the remaining control signals (V_{CLK3}, V_{CLK4}, Vᵣₐᵢₗ₃, Vᵣₐᵢₗ₄, V_{gate3} and V_{gate4}) in the other charge pump cell unit 70(2), because their falling edges precede the necessary transitions in the other control signals.

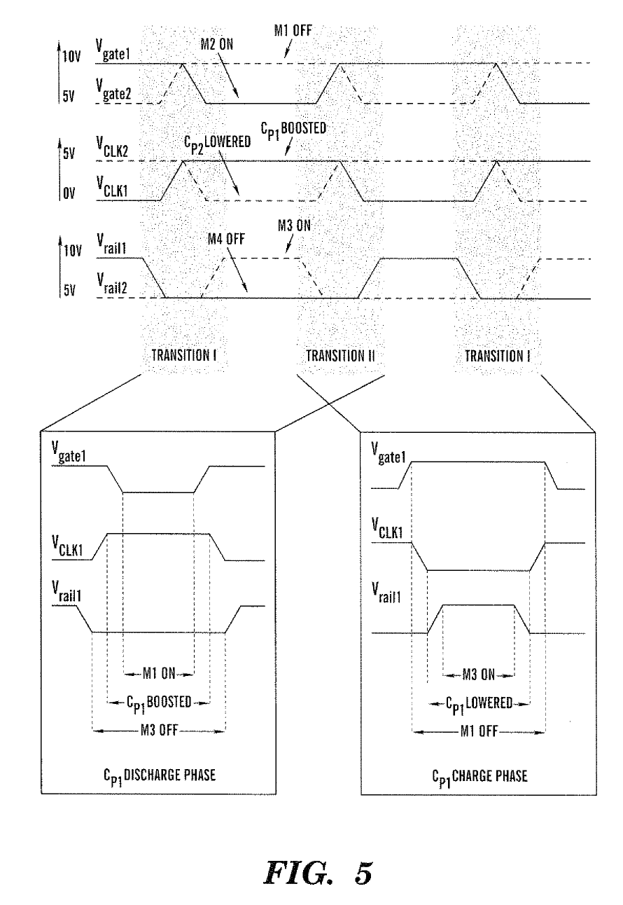

An example of the operation of the charge pump system 20 will now be described with reference to FIGS. 2-3 and 5. An example of a timing diagram for the operation of the charge pump cells 22(1)-22(n) shown in FIG. 3 is illustrated in FIG. 5.

In order to enter the charging phase of one or both of the capacitors Cₚ₁ and Cₚ₂ or 46(1) and 46(2) in one or more of the charge pump cells 22(1)-22(n), one or both of the output switches which comprise MOSFETs M1 and M2 or 50(1) and 50(2) in one or more of the charge pump cells 22(1)-22(n) must be completely turned off before one or both of the bottom plate 52(1) of the capacitor Cₚ₁ or 46(1) and the bottom plate 58(1) of the capacitor Cₚ₂ or 46(2) are lowered back to ground or another fixed baseline. After one or both of the capacitors Cₚ₁ and Cₚ₂ or 46(1) and 46(2) have been completely lowered, one or both of the input switches which comprise MOSFETs M3 and M4 or 54(1) and 54(2) are turned on to recharge one or both the capacitors Cₚ₁ and Cₚ₂ or 46(1) and 46(2).

The charge phase in one or more of the charge pump cells 22(1)-22(n) is controlled by the charge phase timing signals illustrated in FIG. 5. More specifically, in response to the clock signal received at one or more of the inputs 32(1)-32(n) to the clock generators 44 in the charge pump cells 22(1)-22(n), one or more of the clock generator systems 44 generate the signals for the charge phase illustrated in the timing diagram in FIG. 5 to control whether one or both of the capacitors Cₚ₁ and Cₚ₂ or 46(1) and 46(2) in each of the charge pump cells 22(1)-22(n) are charged, although other signals and other manners for controlling the charging of one or more of the capacitors could be used. Once one or both the capacitors Cₚ₁ and Cₚ₂ or 46(1) and 46(2) are charged, the discharge phase can commence.

In order to enter the discharging phase of one or both of the capacitors Cₚ₁ and Cₚ₂ or 46(1) and 46(2), one or both of the output switches which comprise MOSFETs M1 and M2 or 50(1) and 50(2) must be turned on and one or both of the input switches which comprise MOSFETs M3 and M4 or 48(1) and 48(2) must be turned off.

The discharge phase in one or more of the charge pump cells 22(1)-22(n) is controlled by the discharge phase timing signals illustrated in FIG. 5. More specifically, in response to the clock signal received at one or more of the inputs 32(1)-32(n) to the clock generators 44 in the charge pump cells 22(1)-22(n), one or more of the clock generator systems 44 generate the signals for the discharge phase illustrated in the timing diagram in FIG. 5 to control whether one or both of the capacitors Cₚ₁ and Cₚ₂ or 46(1) and 46(2) in each of the charge pump cells 22(1)-22(n) are discharged to the voltage outputs 66 which are coupled to the voltage output 30 of the charge pump system 20, although other signals and other manners for controlling the discharging of one or more of the capacitors could be used. After one or both of the capacitors Cₚ₁ and Cₚ₂ or 46(1) and 46(2) in one or more of the charge pump cells 22(1)-22(n) have been discharged, then the charging phase described herein can commence again.

During the discharging phase, the voltage regulator system 26 samples the output voltage at output 30 with voltage sampling system 34 non-intrusively, i.e. without loading the voltage output 30, although other types of voltage sampling or measurement can be used. The voltage regulator system 26 compares this sampled voltage to a pre-established reference voltage from voltage reference system 38 in the error amplifier system 36, although other manners for determining a difference between the sampled voltage and a reference can be used. The error amplifier system 36 amplifies the difference between these two voltages which is output to voltage-to-frequency converter system 40. The voltage-to-frequency converter system 40 generates a signal to one or more of the clock inputs 32(1)-32(n) for the charge pump cells 22(1)-22(n) to increase, remain the same, or decrease the clocking frequency of one or more of the charge pump cells 22(1)-22(n) based on the amplified difference. As a result, the charge pump system 20 delivers more, the same, or less charge to the voltage output 30 depending on the signal being received from the voltage-to-frequency converter system 40, although the charge pump cells 22(1)-22(n) in one or more of the charge pump cells 22(1)-22(n) could be controlled in other manners.

In order to maximize power efficiency with embodiments of the present invention, static currents are kept to a minimum. For example, the voltage sampling system 34 samples the output voltage without loading the voltage output 30 to keep static currents to a minimum. Additionally, with prior systems, poor control of the switches in the charge pump cells led to leakage currents from the output toward the floating capacitor and input. Accordingly, to address this issue, embodiments of the present invention use the nested multi-phase clock timing scheme which is illustrated in the FIG. 3 and in the accompanying timing diagram shown in FIG. 5.

More specifically, the nested multi-phase clock timing scheme ensures that, during the discharge phase, the input switches which comprise one or both MOSFETs M3 and M4 or 48(1) and 48(2) in one or more of the charge pump cells 22(1)-22(n) are completely turned off before one or more of the capacitors Cₚ₁ and Cₚ₂ or 46(1) and 46(2) are boosted. If the one or more of the capacitors Cₚ₁ and Cₚ₂ or 46(1) and 46(2) are boosted before the output switches which comprise one or both of the MOSFETS M3 and M4 or 48(1) and 48(2) in one or more of the charge pump cells 22(1)-22(n) are completely turned off, part of the charge accumulated in the one or more of the capacitors Cₚ₁ and Cₚ₂ or 46(1) and 46(2) is returned to the voltage input 64, thus reducing voltage conversion efficiency and multiplication factor. The output switches which comprise MOSFETs M1 and M2 or 50(1) and 50(2) in one or more of the charge pump cells 22(1)-22(n) must remain completely turned off during this process, to ensure that no charge stored in the output filtering capacitor (C_{fil}) 68 leaks back to the capacitors Cₚ₁ and Cₚ₂ or 46(1) and 46(2). Such a loss in charge decreases the output voltage, increases voltage ripple, and reduces the voltage conversion efficiency. The output switches which comprise MOSFETs M1 and M2 or 50(1) and 50(2) in one or more of the charge pump cells 22(1)-22(n) are turned on only after the one or more capacitors Cₚ₁ and Cₚ₂ or 46(1) and 46(2) have been boosted to their final value. As illustrated in FIG. 5, clock signal transitions for the negative pulse of V_{gate1} are nested within positive pulse of V_{CLK1}, which in turn are nested within the negative pulse of Vᵣₐᵢₗ₁. Likewise, clock signal transitions for the negative pulse of V_{gate2} are nested within positive pulse of V_{CLK2}, which in turn are nested within the negative pulse of Vᵣₐᵢₗ₂. This clock sequencing insures maximum charge pump efficiency and minimizes transient current shoot through.

Another example of the operation of the charge pump system 20 will now be described with reference to FIGS. 2, 4 and 5. The operation of the charge pump system 20 with the charge pump cells 22(1)-22(n) is the same as the operation of the charge pump system 20 with each of the charge pump cells 22(1)-22(n) replaced with one of the charge pump cells 42, except as described and illustrated herein. Although in this example each of the charge pump cells 22(1)-22(n) replaced with one of the charge pump cells 42, other numbers and types of combinations, types and numbers of charge pump cells can be used. The timing diagram illustrated in FIG. 5 can also be used for the charge pump cell units 70(1) and 70(2) in the charge pump cells 42, with the same timing signals applied to MOSFETs M1, M2, M3, and M4 also being applied to MOSFETs M5, M6, M7, and M8, but with a phase shift which can vary as needed by the particular application. The charge pump cell 42 with the two charge pump cell units 70(1) and 70(2) coupled in parallel is used in order to reduce voltage ripple. The non-overlapping clocks used by the charge pump cell unit 70(2) in each of the charge pump cells 42 is phase shifted with respect to the clocks in the charge pump cell unit 70(1). In this way, the output filtering capacitor 116 is recharged at, effectively, twice the rate, thus reducing voltage ripple.

In order to enter the charging phase of one or both of the capacitors Cₚ₁ and Cₚ₂ or 76(1) and 76(2) in charge pump cell unit 70(1) in one or more of the charge pump cells 42, one or both of the output switches which comprise MOSFETs M1 and M2 or 80(1) and 80(2) in charge pump cell unit 70(1) in one or more of the charge pump cells 42 must be completely turned off before one or both of the bottom plate 90(1) of the capacitor Cₚ₁ or 76(1) and the bottom plate 96(1) of the capacitor Cₚ₂ or 76(2) are lowered back to ground or another fixed baseline. Similarly, in order to enter the charging phase one or both of the capacitors Cₚ₃ and Cₚ₄ or 104(1) and 104(2) in charge pump cell unit 70(2) in one or more of the charge pump cells 42, one or both of the output switches which comprise MOSFETs M5 and M6 or 88(1) and 88(2) in charge pump cell unit 70(2) in one or more of the charge pump cells 42 must be completely turned off before one or both of the bottom plate 104(1) of the capacitor Cₚ₃ or 84(1) and the bottom plate 110(1) of the capacitor Cₚ₄ or 84(2) are lowered back to ground or another fixed baseline. After one or both of the capacitors Cₚ₁ and Cₚ₂ or 76(1) and 76(2) have been completely lowered, one or both of the input switches which comprise MOSFETs M3 and M4 or 78(1) and 78(2) are turned on to recharge one or both the capacitors Cₚ₁ and Cₚ₂ or 76(1) and 76(2). Additionally, after one or both of the capacitors Cₚ₃ and Cₚ₄ or 104(1) and 104(2) have been completely lowered, one or both of the input switches which comprise MOSFETs M7 and M8 or 86(1) and 86(2) are turned on to recharge one or both the capacitors Cₚ₃ and Cₚ₄ or 104(1) and 104(2).

The charge phase in one or more of the charge pump cell units 70(1) and 70(2) in one or more of the charge pump cells 42 is controlled by the charge phase timing signals illustrated in FIG. 5. More specifically, in response to the clock signal received at the clock generators 74 and 82 in the charge pump cells 42 from the frequency regulator 72 which receives the clock signal from the voltage-to-frequency converter system 40, one or more of the clock generator systems 74 and 82 generate the signals for the charge phase illustrated in the timing diagram in FIG. 5 to control whether one or more of the capacitors Cₚ₁ and Cₚ₂ or 76(1) and 76(2) and the capacitors Cₚ₃ and Cₚ₄ or 104(1) and 104(2) in each of the charge pump cells 42 are charged, although other signals and other manners for controlling the charging of one or more of the capacitors could be used. Once one or more of the capacitors Cₚ₁ and Cₚ₂ or 76(1) and 76(2) and capacitors Cₚ₃ and Cₚ₄ or 104(1) and 104(2) are charged, the discharge phase can commence.

Voltage conversion efficiency in prior cross-coupled, charge pump cells is severely reduced at low or zero loading conditions. This occurs because these prior charge pump cells continue to dissipate dynamic power even if the output filtering capacitor is not being discharged. Embodiments of the present invention overcome this problem by incorporating the frequency regulator system 72 that reduces the frequency of the non-overlapping clocks when the output voltage is high as illustrated in FIG. 5.

In order to enter the discharging phase of one or more of the capacitors Cₚ₁ and Cₚ₂ or 76(1) and 76(2) in one or more charge pump cells 42, one or both of the output switches which comprise MOSFETs M1 and M2 or 80(1) and 80(2) in one or more charge pump cells 42 must be turned on and one or both of the input switches which comprise MOSFETs M3 and M4 or 76(1) and 76(2) in one or more charge pump cells 42 must be turned off. Additionally, in order to enter the discharging phase of one or more of the capacitors Cₚ₃ and Cₚ₄ or 104(1) and 104(2) in one or more charge pump cells 42, one or both of the output switches which comprise MOSFETs M5 and M6 or 88(1) and 88(2) in one or more charge pump cells 42 must be turned on and one or both of the input switches which comprise MOSFETs M7 and M8 or 84(1) and 84(2) in one or more charge pump cells 42 must be turned off.

The discharge phase in one or more of the charge pump cell units 70(1) and 70(2) in one or more of the charge pump cells 42 is controlled by the discharge phase timing signals illustrated in FIG. 5. More specifically, in response to the clock signal received at the clock generators 74 and 82 in the charge pump cells 42 from the frequency regulator 72 which receives the clock signal from the voltage-to-frequency converter system 40, one or more of the clock generator systems 74 and 82 generate the signals for the discharge phase illustrated in the timing diagram in FIG. 5 to control whether one or more of the capacitors Cₚ₁ and Cₚ₂ or 76(1) and 76(2) and the capacitors Cₚ₃ and Cₚ₄ or 104(1) and 104(2) in each of the charge pump cells 42 are discharged, although other signals and other manners for controlling the discharging of one or more of the capacitors could be used. Once one or more of the capacitors Cₚ₁ and Cₚ₂ or 76(1) and 76(2) and capacitors Cₚ₃ and Cₚ₄ or 104(1) and 104(2) are discharged, the charge phase can commence again. The operation of the voltage regulator system 26 in this embodiment is the same as previously described and thus will not be described again here.

Accordingly, the present invention provides a number of advantages including providing an effective and area efficient, charge pump system. Additionally, the present invention enables a flat panel display to have only one power supply connection from which voltage levels for all other subsystems can be generated.

Having thus described the basic concept of the invention, it will be rather apparent to those skilled in the art that the foregoing detailed disclosure is intended to be presented by way of example only, and is not limiting. Various alterations, improvements, and modifications will occur and are intended to those skilled in the art, though not expressly stated herein. These alterations, improvements, and modifications are intended to be suggested hereby, and are within the spirit and scope of the invention. Additionally, the recited order of processing elements or sequences, or the use of numbers, letters, or other designations therefore, is not intended to limit the claimed processes to any order except as may be specified in the claims. Accordingly, the invention is limited only by the following claims and equivalents thereto.

What is claimed is:

1. A charge pump system comprising:
a plurality of charge pump cells coupled in series between an input and an output; and
a voltage regulator system coupled to an output from the plurality of charge pump cells and to each of the plurality of charge pump cells to control at least one of a charge and a discharge of one or more of the plurality of charge pump cells.

2. The system as set forth in claim 1 wherein at least one of the plurality of charge pump cells comprises:
at least one clock generator system;
two or more capacitors coupled to the at least one clock generator system;
two or more input switches coupled to the at least one clock generator system, each of the input switches coupled in series between the input to the plurality of charge pump cells and one of the capacitors; and
two or more output switches coupled to the at least one clock generator system, each of the output switches coupled in series between the output to the plurality of charge pump cells and one of the capacitors.

3. The system as set forth in claim 2 wherein the two or more input switches and the two or more output switches each comprise at least on field effect transistor.

4. The system as set forth in claim 2 further comprising at least one frequency regulator system which is coupled to the at least one clock generator system.

5. The system as set forth in claim 2 wherein at least one of the plurality of charge pump cells and the capacitors is made with a high-k dielectric material.

6. The system as set forth in claim 1 wherein the voltage regulator system comprises:
a voltage sampling system coupled to an output from the plurality of charge pump cells;
an error amplifier system coupled to the voltage sampling system and a voltage reference system; and
a voltage-to-frequency converter system coupled to the error amplifier system and each of the plurality of charge pump cells.

7. The system as set forth in claim 1 further comprising a filtering system coupled between the plurality of charge pump cells and the output.

8. The system as set forth in claim 7 wherein the filter system comprises a filter capacitor.

9. The system as set forth in claim 8 wherein the filter capacitor is made with a high-k dielectric material.

10. A method for making a charge pump system, the method comprising:
forming a plurality of charge pump cells which are coupled in parallel between an input and an output; and
coupling a voltage regulator system to an output from the plurality of charge pump cells and to each of the plurality of charge pump cells to provide a clocking signal to control at least one of a charge and a discharge of one or more of the plurality of charge pump cells.

11. The method as set forth in claim 10 wherein the forming a plurality of charge pump cells further comprises for at least one of the plurality of charge pump cells:
providing at least one clock generator system;
coupling two or more capacitors to the at least one clock generator system;
coupling two or more input switches to the at least one clock generator system, each of the input switches is coupled in series between the input to the plurality of charge pump cells and one of the capacitors; and
coupling two or more output switches to the at least one clock generator system, each of the output switches is coupled in series between the output to the plurality of charge pump cells and one of the capacitors.

12. The method as set forth in claim 11 wherein the two or more input switches and the two or more output switches each comprise at least one field effect transistor.

13. The method as set forth in claim 11 further comprising coupling at least one frequency regulator system to the at least one clock generator system.

14. The method as set forth in claim 12 wherein at least one of the plurality of charge pump cells and one of the capacitors is made with a high-k dielectric material.

15. The method as set forth in claim 10 wherein the voltage regulator system further comprises:
coupling a voltage sampling system to an output from the plurality of charge pump cells;
coupling an error amplifier system coupled to the voltage sampling system and a voltage reference system; and
coupling a voltage-to-frequency converter system to the error amplifier system and each of the plurality of charge pump cells.

16. The method as set forth in claim 10 further comprising coupling a filtering system between the plurality of charge pump cells and the output.

17. The method as set forth in claim 16 wherein the filter system comprises a filter capacitor.

18. The method as set forth in claim 17 wherein the filter capacitor is made with a high-k dielectric material.
